(19) United States
(12) Patent Application Publication
(10) Pub. No.: US 2020/0039249 A1
(43) Pub. Date: Feb. 6, 2020

(54) SHEET CONVEYANCE DEVICE AND IMAGE FORMING SYSTEM INCLUDING THE SAME

(71) Applicant: KYOCERA Document Solutions Inc., Osaka (JP)

(72) Inventors: Masayuki KAKUTA, Osaka (JP); Masami FUCHI, Osaka (JP); Sachio IZUMICHI, Osaka (JP); Seiji OKADA, Osaka (JP); Risa HIBINO, Osaka (JP)

(73) Assignee: KYOCERA Document Solutions Inc., Osaka (JP)

(21) Appl. No.: 16/510,659

(22) Filed: Jul. 12, 2019

(30) Foreign Application Priority Data
Jul. 31, 2018 (JP) 2018-143318

(51) Int. Cl. B41J 11/00; B65H 5/38; B65H 5/06

(52) U.S. Cl. CPC B41J 11/0045; B65H 5/062; B65H 5/38

(57) ABSTRACT

A sheet conveyance device 10 includes a first conveyance path 12a having a linear portion 121 along which a sheet is to be linearly conveyed, a second conveyance path 12b branched from the linear portion 121 and a branch member 30 which is to be set selectively to a first position for guiding the sheet to a downstream side of the first conveyance path 12a or a second position for guiding the sheet to the second conveyance path 12b. The branch member 30 is made up of a resinous guide body 31 having a first guide surface 31a for guiding the sheet to a downstream side of the first conveyance path 12a, and a metallic guide plate 35. A second guide surface 35a for guiding the sheet to the second conveyance path 12b is formed of the resinous guide body 31 and the metallic guide plate 35.

### INCORPORATION BY REFERENCE

This application is based upon and claims the benefit of priority from the corresponding Japanese Patent Application No. 2018-143318 filed on Jul. 31, 2018, the entire contents of which are incorporated herein by reference.

### BACKGROUND

The present disclosure relates to a sheet conveyance device and an image forming system including the sheet conveyance device. In particular, the disclosure relates to a sheet conveyance device equipped with a branch member which is swingably provided at a branch portion of a sheet conveyance path, the disclosure further relating to an image forming system including the sheet conveyance device.

As a sheet conveyance device for conveying sheets having images formed thereon, conventionally, there is known a sheet conveyance device capable of sorting sheets into sheet conveyance destinations. This sheet conveyance device includes a first conveyance path having a linear portion along which a sheet is to be linearly conveyed, a second conveyance path branched from the linear portion of the first conveyance path, a branch member swingably provided at the branch portion of the first conveyance path, and a drive mechanism for swinging the branch member. The branch member can be positioned selectively at a first position for guiding a sheet to the downstream side of the first conveyance path or a second position for guiding a sheet onto the second conveyance path, allowing sheets to be sorted out in terms of sheet conveyance destinations.

When a sheet is guided onto the second conveyance path branched from the linear portion of the first conveyance path, the sheet strongly rubs against the branch member. Since the branch member is made commonly from resin, there is a problem that the branch member may be gradually scraped off due to the rubbing of the sheet.

### SUMMARY

A sheet conveyance device according to the present disclosure comprises:
a first conveyance path having a linear portion along which a sheet is to be linearly conveyed;
a second conveyance path branched from the linear portion of the first conveyance path;
a branch member which is provided at a branch portion branched from the first conveyance path to the second conveyance path and which is to be set selectively to a first position for guiding the sheet to a downstream side of the first conveyance path or a second position for guiding the sheet to the second conveyance path; and
a drive mechanism for switching the branch member between the first position and the second position.
The branch member includes:
a resinous guide body having, in a first surface thereof, a first guide surface for guiding the sheet to the downstream side of the first conveyance path and, in a second surface thereof on back of the first surface, a second guide surface for guiding the sheet to the second conveyance path; and
a metallic guide plate which is fixed to the second surface of the resinous guide body to make up the second guide surface in combination with the resinous guide body.

Further features and advantages of this disclosure will become apparent by an embodiment thereof described hereinbelow.

### BRIEF DESCRIPTION OF THE DRAWINGS

FIG. 1 is an outlined view showing an internal configuration of an image forming apparatus, a relay conveyance device and a sheet postprocessing device, of which an image forming system according to an embodiment of the disclosure is made up.

FIG. 2 is a sectional view showing a structure of around a branch member of the relay conveyance device, depicting a state in which the branch member is set in the first position.

FIG. 3 is a sectional view showing the structure of around the branch member of the relay conveyance device, depicting a state in which the branch member is set in the second position.

FIG. 4 is a perspective view showing a structure of the branch member and a drive mechanism in the relay conveyance device as viewed from above.

FIG. 5 is a perspective view showing the structure of the branch member and the drive mechanism in the relay conveyance device, as viewed from below.

FIG. 6 is a view showing a structure of around the drive mechanism of the relay conveyance device, depicting a state in which the branch member is set in the first position.

FIG. 7 is a view showing a structure of around the drive mechanism of the relay conveyance device, depicting a state in which the branch member is set in the second position.

FIG. 8 is a view showing a structure of around a torsion spring of the relay conveyance device.

### DETAILED DESCRIPTION

An embodiment of the present disclosure will be described hereinbelow with reference to the accompanying drawings.

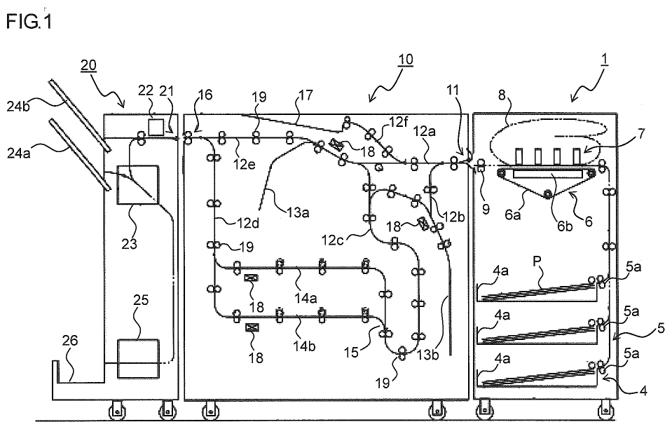

FIG. 1 is an outlined view showing an internal configuration of an image forming apparatus 1, a relay conveyance device 10 and a sheet postprocessing device 20, of which an image forming system is made up. With reference to FIG. 1, first described below is the image forming system made up of the image forming apparatus 1, the relay conveyance device 10, i.e. one example of the sheet conveyance device according to the disclosure, and the sheet postprocessing device 20.

The image forming apparatus 1 is an ink-jet recording type printer, which includes a sheet containing part 4, a sheet feeding part 5, a sheet conveyance part 6, an image recording part 7, and a reverse conveyance part 8. The sheet containing part 4 is provided in a lower part of in the image forming apparatus 1. The sheet feeding part 5 is provided beside and above the sheet containing part 4. The sheet conveyance part 6 is provided above the sheet containing part 4. The image recording part 7 is provided above and opposite the sheet conveyance part 6. The reverse conveyance part 8 is provided above the image recording part 7.

In the sheet containing part 4, a plurality (three in this case) of sheet cassettes 4a on which a bundle of paper sheets P are to be set are provided settable and removable. The sheet feeding part 5 feeds sheets P contained in the sheet containing part 4 to the sheet conveyance part 6 by means of sheet feed roller pairs 5a provided sheet-feed downstream of the sheet cassettes 4a, respectively.

The sheet conveyance part 6 includes an endless conveyance belt 6a stretched over a plurality of rollers including a drive roller. A multiplicity of vent holes (not shown) for air suction are formed in the conveyance belt 6a. A sheet P fed out from the sheet feeding part 5 passes under the image recording part 7 as it is sucked and held on the conveyance belt 6a by a sheet sucking portion 6b provided inside the conveyance belt 6a.

The image recording part 7 includes a plurality of ink jet heads for jetting out ink toward the sheet P being conveyed as it is sucked and held on the conveyance belt 6a. These ink jet heads are fed with ink of four colors (cyan, magenta, yellow and black), respectively, reserved in ink tanks (not shown).

For double-sided recording of a sheet P, the reverse conveyance part 8 changes over (switches back) the conveyance direction of the sheet P having finished with one-side recording, by which the sheet P is reversed between its top and back sides. Thereafter, the reverse conveyance part 8 conveys the sheet P, with its no-image-recorded face oriented upward, again to the image recording part 7. The sheet P, on which a specified image has been recorded by the image recording part 7, is discharged through a discharge roller pair 9 so as to be carried into the relay conveyance device 10.

The relay conveyance device 10 performs reversal process of reversing the top and back of the sheet P with an image recorded thereon by the image forming apparatus 1, and drying process of drying the ink deposited on the sheet P. As shown in FIG. 1, the sheet P carried in through a relay carry-in opening 11 of the relay conveyance device 10 is conveyed through a first conveyance route 12a to a first reversal tray 13a. After accepting the sheet P conveyed along the first conveyance route 12a, the first reversal tray 13a changes over (switches back) the conveyance direction to reverse the top and back sides of the sheet P.

A second conveyance route 12b branched from the first conveyance route 12a is also provided. The sheet P having passed through the second conveyance route 12b is conveyed to a second reversal tray 13b. The second reversal tray 13b, after accepting the sheet P conveyed along the second conveyance route 12b, changes over (switches back) the conveyance direction to reverse the top and back sides of the sheet P.

The sheet P reversed between the top and back sides of the sheet P by the first reversal tray 13a or the second reversal tray 13b is conveyed through a third conveyance route 12c to a bypass conveyance path 14a or 14b. The bypass conveyance paths 14a, 14b are enabled to temporarily halt (set on standby) the sheet P in response to processing contents executed by the sheet postprocessing device 20.

The bypass conveyance paths 14a, 14b differ from each other in distance from a branch portion 15 to a sheet halt position (horizontal portion in FIG. 1). Because of this, for example, a first-coming sheet P reversed by the first reversal tray 13a is halted within the bypass conveyance path 14a, and a second-coming sheet P reversed by the second reversal tray 13b is halted within the bypass conveyance path 14b. Thus, conveyance of the sheets P can be resumed again as a sheet distance therebetween is maintained.

A sheet having passed through the bypass conveyance path 14a or 14b is conveyed through a fourth conveyance route 12d and discharged through a relay carry-out opening 16, thus being carried into the sheet postprocessing device 20. In a case where a sheet P is conveyed to the sheet postprocessing device 20 without being subjected to reversal process, the sheet P is conveyed through a fifth conveyance route 12e branched from the first conveyance route 12a on the upstream side of the first reversal tray 13a, thus being discharged through the relay carry-out opening 16. Further, the sheet P that is not carried into the sheet postprocessing device 20 is conveyed through a sixth conveyance route 12f branched from the first conveyance route 12a, thus being discharged onto a relay discharge tray 17.

Fans 18 for blowing air to the sheet P to dry ink are provided on the first conveyance path 12a, the second conveyance path 12b, and the bypass conveyance paths 14a, 14b, respectively. Also, conveyance roller pairs 19 for conveying the sheet P are provided at proper places on the first conveyance route 12a to sixth conveyance route 12f and the bypass conveyance paths 14a, 14b.

The sheet postprocessing device 20 is coupled to a conveyance-downstream side of the relay conveyance device 10. A sheet P that has passed through the relay conveyance device 10 after having an image recorded thereon by the image forming apparatus 1 is subjected to postprocessing such as punch-hole forming process and binding process by the sheet postprocessing device 20.

As shown in FIG. 1, the sheet postprocessing device 20 internally includes a punch-hole forming device 22, an edge-binding unit 23, and a saddle-binding and middle-folding unit 25. The punch-hole forming device 22 forms punch holes in the sheet P carried in through a sheet carry-in opening 21. The edge-binding unit 23 stacks a plurality of carried-in sheets P together to bundle and staple the sheets P with their edges aligned. The saddle-binding and middle-folding unit 25 staples the bundle of sheets P at their middle portion and thereafter folds the bundled sheets P into a booklet form with their stapled portion taken as a center.

Further, a main tray 24a enabled to move up and down to a position suitable for discharge of sheets P, as well as a sub tray 24b fixed at an upper portion of the sheet postprocessing device 20, are provided on a side face of the sheet postprocessing device 20.

The punch-hole forming device 22 is placed at an upper site in the sheet postprocessing device 20. A sheet P subjected to image formation in the image forming apparatus 1 is fed via the sheet carry-in opening 21 provided at an upper right site as in the figure of the sheet postprocessing device 20, then passing through the punch-hole forming device 22. When not subjected to the stapling process, the sheet P that has passed through the punch-hole forming device 22 is discharged, as it is, onto the sub tray 24b. When subjected to the stapling process, the sheet P that has passed through the punch-hole forming device 22 is conveyed to the edge-binding unit 23 or the saddle-binding and middle-folding unit 25, which are placed below the punch-hole forming device 22.

The edge-binding unit 23 is made up of a stapler and a processing tray (neither shown) or the like. A bundle of sheets P stacked on the processing tray, as those sheets are aligned at a leading edge of the bundle, is bound at the end by the stapler provided at an end portion of the processing tray. Thereafter, the bundle of sheets P with the end portion bound is discharged along the processing tray onto the main tray 24a.

The saddle-binding and middle-folding unit 25, which is placed below the edge-binding unit 23, is made up of a saddle-binding stapler, a middle-folding device, a sheet guide (none shown), and the like. The saddle-binding stapler is to staple a middle portion of the bundle of sheets P stacked together within the sheet guide. The bundle of sheets P subjected to stapling process by the saddle-binding stapler is folded into a booklet form, as it is centered on a stapling portion, by the middle-folding device, and thereafter discharged onto a booklet tray 26.

Next, a structure of around a branch portion 121a where the second conveyance route (second conveyance path) 12b is branched from the first conveyance route (first conveyance path) 12a in the relay conveyance device 10 will be described below.

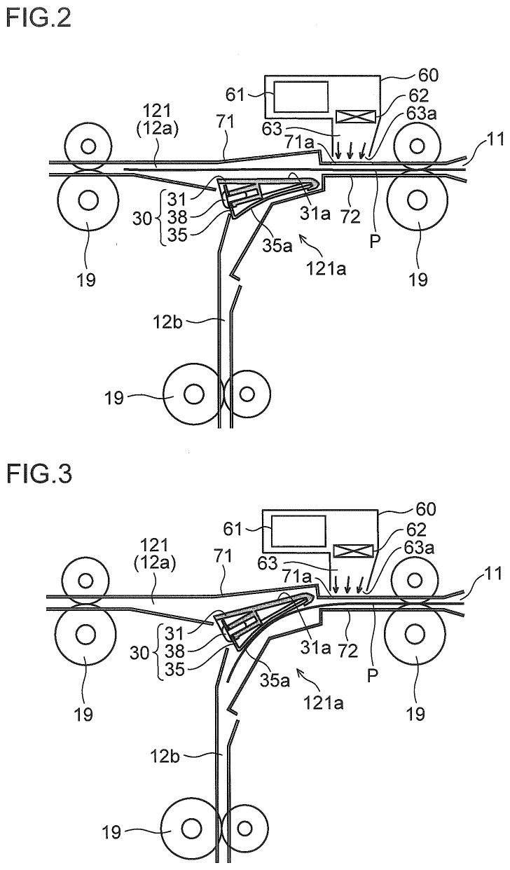

As shown in FIGS. 1 and 2, the first conveyance route 12a has a linear portion 121 which is connected to the relay carry-in opening 11 and along which the sheet P is to be conveyed horizontally and linearly. The second conveyance route 12b is branched so as to be curved downward (in a direction perpendicular to the first conveyance route 12a) from a specified position (hereinafter, referred to as branch portion 121a) of the linear portion 121 of the first conveyance route 12a. In addition, conveyance roller pairs (conveyance members) 19 are provided on upstream and downstream sides, respectively, of the branch portion 121a of the first conveyance route 12a.

In the branch portion 121a, a branch member 30 is provided swingable. By swinging motion, the branch member 30 is selectively set to a first position (position of FIG. 2) for guiding the sheet P to the downstream side of the first conveyance route 12a or to a second position (position of FIG. 3) for guiding the sheet P to the second conveyance route 12b.

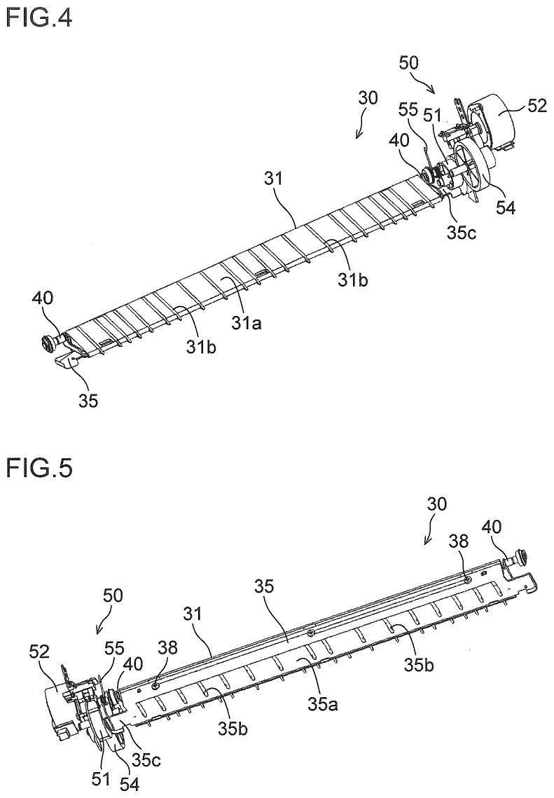

The branch member 30 is made up of a resinous guide body 31 (see FIGS. 2 and 4) and a metallic guide plate 35 (see FIGS. 3 and 5). The resinous guide body 31 has, in its first surface (upper surface in this case), a first guide surface 31a for guiding the sheet P to the downstream side of the first conveyance route 12a. The metallic guide plate 35 is fixed to a second surface (lower surface in this case) on the back side of the first surface of the resinous guide body 31.

Part of the second surface of the resinous guide body 31, as well as the metallic guide plate 35, form a second guide surface 35a for guiding the sheet P to the second conveyance route 12b. In this case, the resinous guide body 31 is placed forward in the conveyance direction on the second guide surface 35a, while the metallic guide plate 35 is rearward in the conveyance direction on the second guide surface 35a. The second guide surface 35a has such a curved shape as to guide a leading edge of the sheet P to the second conveyance route 12b. It is noted that FIGS. 2 and 3 each show a cross section of an axial end portion of the branch member 30, the cross section being such that the resinous guide body 31 is not exposed onto the second guide surface 35a.

As shown in FIGS. 4 and 5, the resinous guide body 31 and the metallic guide plate 35, both extending in a sheet width direction, are provided over an entire range of a sheet passage area. On the first guide surface 31a of the resinous guide body 31, a plurality of ribs 31b extending in the sheet conveyance direction are provided with specified intervals set along the sheet width direction. On the second guide surface 35a of the metallic guide plate 35, a plurality of ribs 35b extending in the sheet conveyance direction are provided with specified intervals set along the sheet width direction.

The metallic guide plate 35 is fixed to the back side of the first guide surface 31a of the resinous guide body 31 with use of a plurality (three in this case) of screws 38. The branch member 30, as shown in FIG. 2, is formed into a hollow shape from the resinous guide body 31 and the metallic guide plate 35, allowing a weight reduction to be realized.

Sheet-widthwise both end portions of the branch member 30, as shown in FIG. 4, are swingably supported on a swing shaft 40 provided in a frame of the relay conveyance device 10. As to the branch member 30, its upstream end swings up and down about the swing shaft 40 as a center.

On one side (right side in FIG. 4) of the branch member 30 in the sheet width direction, a drive mechanism 50 is provided to switch the branch member 30 between the first position and the second position.

More specifically, as shown in FIG. 5, a pressed portion 35c, which is to be pressed, is provided at sheet-widthwise one end (left end in FIG. 5) of the metallic guide plate 35 of the branch member 30. The pressed portion 35c is protruded sheet-widthwise outward of the resinous guide body 31.

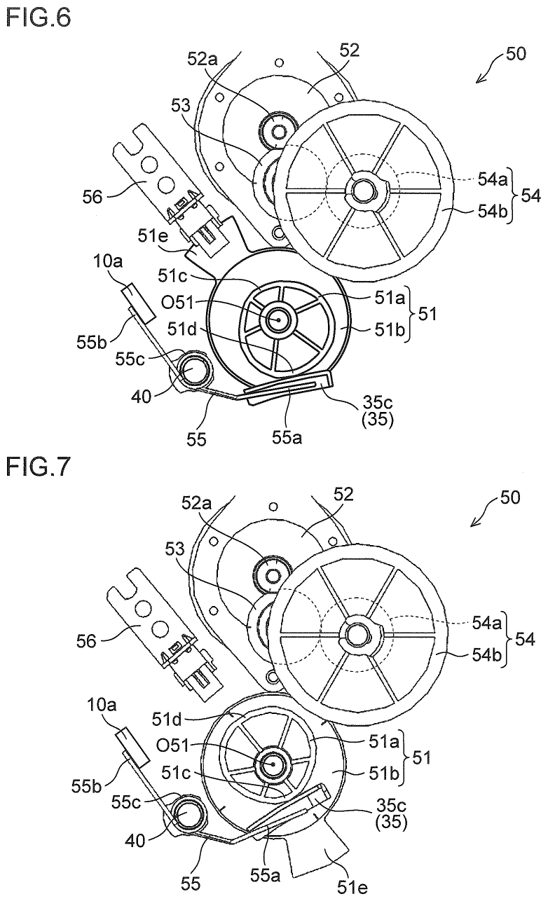

The drive mechanism 50, as shown in FIG. 6, is made up of an eccentric cam 51, a motor (drive source) 52, an idle gear 53, a two-speed gear 54, a torsion spring (biasing member) 55, and a detection sensor 56. The eccentric cam 51 presses the pressed portion 35c in a specified direction. The motor 52 generates driving force for driving the eccentric cam 51. The idle gear 53 and the two-speed gear 54 transmit the driving force from the motor 52 to the eccentric cam 51. The torsion spring (biasing member) 55 biases the pressed portion 35c in a direction opposite to the pressing direction by the eccentric cam 51. It is noted that the drive mechanism 50 is controlled by a control section (not shown) that controls the whole relay conveyance device 10.

The idle gear 53 is meshed with a motor gear 52a fixed to a rotating shaft of the motor 52. The two-speed gear 54 is formed of a small-diameter gear 54a to be meshed with the idle gear 53, and a large-diameter gear 54b formed integral with the small-diameter gear 54a.

The eccentric cam 51 has a cam portion 51a which varies in distance from a rotational center O51 to its outer circumferential surface, and a gear portion 51b placed outwardly adjacent to the cam portion 51a as viewed in the sheet width direction. The cam portion 51a and the gear portion 51b are formed integral with each other.

The cam portion 51a has a small-diameter portion 51c and a large-diameter portion 51d larger in diameter than the small-diameter portion 51c. When the large-diameter portion 51d presses the pressed portion 35c by rotation of the eccentric cam 51 with the branch member 30 in the second position shown in FIG. 7, the branch member 30 swings clockwise as viewed in the figure. As a result, the branch member 30 is set into the first position shown in FIG. 6. Meanwhile, when the small-diameter portion 51c presses the pressed portion 35c by rotation of the eccentric cam 51 with the branch member 30 in the first position shown in FIG. 6, the branch member 30 swings counterclockwise as viewed in the figure. As a result, the branch member 30 is set into the second position shown in FIG. 7.

A tooth portion to be meshed with the large-diameter gear 54b of the two-speed gear 54, and a light-shield portion 51e, are provided on the outer circumferential surface of the gear portion 51b. The detection sensor 56 has a light-emitting portion and a light-receiving portion (neither shown) which are to be placed in opposition to each other so as to sandwich the light-shield portion 51e of the gear portion 51b in its thicknesswise direction. As the eccentric cam 51 is pivoted, an optical path between the light-emitting portion and the light-receiving portion is changed over between optical transmission and shielding state. As a result of this, it becomes possible to detect an angular position of the eccentric cam 51, i.e. a swinging position of the branch member 30, by the detection sensor 56.

The torsion spring 55 has a coil spring portion 55c to be externally fitted to the swing shaft 40 on one side (right side in FIG. 4) in the sheet width direction. The torsion spring 55 further has one end part 55a, which extends in a radial direction of the coil spring portion 55c, as well as the other end part 55b. The one end part 55a is put into contact with the pressed portion 35c to bias the pressed portion 35c upward. The other end part 55b, extending from the coil spring portion 55c in a direction different from the one end part 55a, is to be put into contact with a metallic frame 10a of the relay conveyance device 10 so as to be engaged therewith. The other end part 55b may also be fixed to the frame 10a. In addition, the frame 10a is electrically grounded.

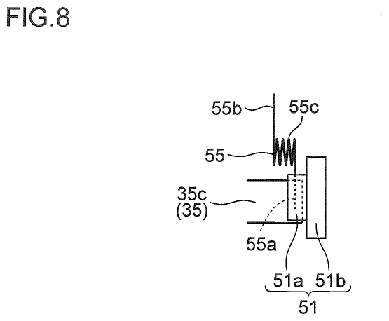

The torsion spring 55, as shown in FIGS. 7 and 8, is placed in opposition to the eccentric cam 51 with the pressed portion 35c interposed therebetween. That is, the torsion spring 55 is so placed as to overlap with the eccentric cam 51 in the sheet width direction. In this case, the one end part 55a of the torsion spring 55 is placed at the same position as the cam portion 51a of the eccentric cam 51 in terms of the sheet width direction. Therefore, in terms of the sheet width direction, a biasing position of the torsion spring 55 against the pressed portion 35c and a pressing position of the eccentric cam 51 against the pressed portion 35c are set to one identical position.

As shown in FIG. 2, a warm air device 60 is provided upstream of the branch portion 121a on the first conveyance route 12a. The warm air device 60 is made up of a heater 61, a blower fan 62, and a duct 63. The duct 63 has an air flow opening 63a for blowing out an air flow (warm air) generated by the blower fan 62 toward the first conveyance route 12a. As a result of this, the warm air device 60 blows warm air onto the sheet P conveyed in the first conveyance route 12a to dry the ink on the sheet P.

The first conveyance route 12a is made up of an upper guide (a first guide member) 71 and a lower guide (a second guide member) 72. In a portion of the upper guide 71 facing the air flow opening 63a of the warm air device 60, a slit 71a is formed so as to allow warm air to pass therethrough. The slit 71a is formed so as to extend in the sheet conveyance direction, and is provided in plurality with specified intervals from one another in the sheet width direction. The warm air device 60 may be provided so as to face the lower guide 72 and a slit like the one above may be formed in a portion of the lower guide 72 facing the air flow opening 63a of the warm air device 60.

In this embodiment, as described above, the branch member 30 is made up of the resinous guide body 31 having the first guide surface 31a for guiding the sheet P toward the downstream side of the first conveyance route 12a, and the metallic guide plate 35 fixed to the back side of the first guide surface 31a in the resinous guide body 31. Then, the second guide surface 35a for guiding the sheet P to the second conveyance route 12b is formed of the resinous guide body 31 and the metallic guide plate 35.

Thus, by the second guide surface 35a including the metallic guide plate 35 of the branch member 30, the sheet P is guided to the second conveyance route 12b branched from the linear portion 121 of the first conveyance route 12a. Therefore, even when the sheet P has intensely rubbed against the branch member 30, by virtue of the metallic guide plate 35 being metallic, the branch member 30 can be prevented from being scraped off due to the rubbing of the sheet P.

Also, by virtue of the branch member 30 being made up of the resinous guide body 31 and the metallic guide plate 35, the branch member 30 can be prevented from increasing in weight, unlike the case where the whole branch member 30 is formed of sheet metal. For this reason, driving torque necessary to swing the branch member 30 can be suppressed. As a consequence, the motor 52 can be prevented from increasing in size, and moreover increases in power consumption can be suppressed.

Also as described above, in the case where the second conveyance route 12b is formed so as to extend from the branch portion 121a in a direction perpendicular to the first conveyance route 12a, the leading edge of the sheet P more intensely rubs against the second guide surface 35a. Therefore, applying the present disclosure is particularly effective when the second conveyance route 12b is formed so as to extend from the branch portion 121a in a direction perpendicular to the first conveyance route 12a.

Also as described above, the metallic guide plate 35 includes the pressed portion 35c at one end in the sheet width direction, while the drive mechanism 50 includes the eccentric cam 51 for pressing the pressed portion 35c in a specified direction, the motor 52 for driving the eccentric cam 51, and the torsion spring 55 for biasing the pressed portion 35c in a direction opposite to the pressing direction by the eccentric cam 51. As a result of this, the branch member 30 can easily be set selectively to the first position or the second position by rotating the eccentric cam 51.

Also as described above, the torsion spring 55 is placed in opposition to the eccentric cam 51 with the pressed portion 35c interposed therebetween. Therefore, in terms of the sheet width direction, the biasing position of the torsion spring 55 against the pressed portion 35c and the pressing position of the eccentric cam 51 against the pressed portion 35c can be set to one identical position. Thus, the pressed portion 35c can be prevented from being twisted.

Also as described above, the one end part 55a of the torsion spring 55 is in contact with the pressed portion 35c, while the other end part 55b is in contact with the frame 10a. Therefore, static electricity generated at the branch member 30 by the sheet P rubbing thereagainst can be allowed to escape via the torsion spring 55 to the frame 10a.

Also as described above, in the case where the warm air device 60 for blowing warm air to the sheet P passing along the first conveyance route 12a is provided, making the whole branch member from resin would cause the branch member to be liable to thermal deformation. However, the branch member 30 of this embodiment is formed from resin and sheet metal, thus capable of suppressing thermal deformation. Therefore, in the case where the warm air device 60 for blowing warm air toward the first conveyance route 12a is provided, applying this disclosure is particularly effective.

The embodiment disclosed herein should be construed as not being limitative but being an exemplification at all points. The scope of the disclosure is defined not by the above description of the embodiment but by the appended claims, including all changes and modifications equivalent in sense and range to the claims.

For example, in the above-described embodiment, the image forming apparatus 1 is exemplified by an ink jet printer. However, needless to say, the disclosure is also applicable to such devices as copiers, laser printers, and facsimiles other than ink jet printers, as the image forming apparatus 1.

Also, the above embodiment has been described on an example in which the branch member 30 to be placed at the branch portion 121a in downstream-side proximity to the relay carry-in opening 11 is made up of the resinous guide body 31 and the metallic guide plate 35. However, the disclosure is not limited to this. A branch member to be placed at another branch portion (e.g., branch portion 15 of FIG. 1) may be made up of the resinous guide body 31 and the metallic guide plate 35.

Also, the above embodiment has been described on an example in which the disclosure is applied to the relay conveyance device 10 coupled to the image forming apparatus 1. However, the disclosure is not limited to this. The sheet conveyance device of the disclosure may also be one which is contained in the image forming apparatus 1 to form part of the image forming apparatus 1, as an example.

What is claimed is:

1. A sheet conveyance device comprising:
a first conveyance path having a linear portion along which a sheet is to be linearly conveyed;
a second conveyance path branched from the linear portion of the first conveyance path;
a branch member which is provided at a branch portion branched from the first conveyance path to the second conveyance path and which is to be set selectively to a first position for guiding the sheet to a downstream side of the first conveyance path or a second position for guiding the sheet to the second conveyance path; and
a drive mechanism for switching the branch member between the first position and the second position, wherein
the branch member includes:
a resinous guide body having, in a first surface thereof, a first guide surface for guiding the sheet to the downstream side of the first conveyance path and, in a second surface thereof on back of the first surface, a second guide surface for guiding the sheet to the second conveyance path; and
a metallic guide plate which is fixed to the second surface of the resinous guide body to make up the second guide surface in combination with the resinous guide body.

2. The sheet conveyance device according to claim 1, wherein
the second conveyance path is provided so as to extend from the branch portion in a direction generally perpendicular to the first conveyance path, and the second guide surface has a curved shape along which the sheet is guided.

3. The sheet conveyance device according to claim 1, wherein
the metallic guide plate is formed so as to extend in a sheet width direction perpendicular to a sheet conveyance direction and has a pressed portion, which is to be pressed, at one end thereof in the sheet width direction, and
the drive mechanism includes an eccentric cam for pressing the pressed portion in a specified direction, a drive source for driving the eccentric cam, and a biasing member for biasing the pressed portion in a direction opposite to a pressing direction by the eccentric cam.

4. The sheet conveyance device according to claim 3, wherein
the biasing member is placed in opposition to the eccentric cam with the pressed portion interposed therebetween.

5. The sheet conveyance device according to claim 3, further comprising
a frame which is electrically grounded, wherein
the biasing member is a torsion spring which includes a coil spring portion, a one-end part extending in a radial direction of the coil spring portion and being set in contact with the pressed portion, and an other-end portion set in contact with the frame.

6. The sheet conveyance device according to claim 1, further comprising
a warm air device which is placed on an upstream side of the branch portion on the first conveyance path to blow warm air to the sheet conveyed the first conveyance path, wherein
slits communicating with the first conveyance path so as to allow the warm air to pass therethrough are formed in portions facing the warm air device out of a first guide member and a second guide member opposed to the first guide member, where the first guide member and the second guide member make up the first conveyance path.

7. An image forming system comprising:
the sheet conveyance device according to claim 1; and
an image forming apparatus which is coupled to the sheet conveyance device and which forms an image on a sheet and conveys the sheet having the image formed thereon to the sheet conveyance device.
